(19) United States
(12) Patent Application Publication
(10) Pub. No.: US 2013/0337369 A1
(43) Pub. Date: Dec. 19, 2013

(54) MIXED METAL OXIDE

(71) Applicants: Matthew Rosseinsky, Liverpool (GB); John Claridge, Liverpool (GB); Antoine Demont, Liverpool (GB); Ruth Sayers, Liiverpool (GB)

(72) Inventors: Matthew Rosseinsky, Liverpool (GB); John Claridge, Liverpool (GB); Antoine Demont, Liverpool (GB); Ruth Sayers, Liiverpool (GB)

(73) Assignee: THE UNIVERSITY OF LIVERPOOL, Liverpool (GB)

(21) Appl. No.: 13/884,692

(22) PCT Filed: Nov. 14, 2011
(86) PCT No.: PCT/GB2011/052213

§ 371 Date: Jun. 26, 2013

(30) Foreign Application Priority Data
Nov. 12, 2010 (GB) 1019156.7

(51) Int. Cl. H01M 4/90; C01F 17/00

(52) U.S. Cl. CPC H01M 4/9016; C01F 17/0043
USPC 429/527; 423/594.2; 252/519.15; 429/528

(57) ABSTRACT

The present invention relates to a mixed metal oxide exhibiting perovskite-type structural characteristics in which there are cations of Ba, Ca or Sr, a rare earth metal and Fe, Cr, Cu, Co or Mn present in three different coordination sites or a composition thereof, to a cathode composed of the mixed metal oxide or composition thereof and to a solid oxide fuel cell comprising the cathode.

The present invention relates to a mixed metal oxide exhibiting perovskite-type structural characteristics in which there are cations of Ba, Ca or Sr, a rare earth metal and Fe, Cr, Cu, Co or Mn present in three different coordination sites or a composition thereof, to a cathode composed of the mixed metal oxide or composition thereof and to a solid oxide fuel cell comprising the cathode.

Transition metal oxides are of importance due to their wide array of functional behaviour. Amongst these oxides, the ABO₃ perovskite has a pronounced structural flexibility that allows considerable compositional diversity. This results in a rich array of accessible and chemically tuneable properties. A-site cation and oxygen vacancy ordering are directly linked to the transition metal environment and oxidation state and have a dramatic influence on the targeted behaviour of the compound. Control of these features can be therefore of crucial importance for the generation of interesting new properties.

An important application is in solid oxide fuel cell (SOFC) cathodes. In an SOFC, the cathode is responsible for catalysing the reduction of the O₂ molecule to O²⁻ and must be a mixed electronic conductor (to deliver electrons liberated from the fuel at the anode to reduce O₂) and an ionic conductor (to transport the generated oxide ions via the electrolyte to the anode for fuel oxidation) which is stable in an oxidising atmosphere. Specific structural features (such as the oxygen vacancy layers in NdBaCo₂O₅₊ₓ) have recently been identified as responsible for enhancing cathode properties (in this case by increased oxide ion mobility). This opens up the possibility of enhanced cathode performance in materials where the structure allows the optimisation of all three required functions. The leading cathode candidates are ABO_{3-δ} perovskite-related materials such as Co-rich BSCF (Ba_{0.5}Sr_{0.5}Co_{0.8}Fe_{0.2}O_{3-δ}) and Fe-rich LSCF (La_{0.6}Sr_{0.4}Fe_{0.8}CO_{0.2}O_{3-δ}) where the oxygen vacancies generate the ionic conduction. However the combined challenges of minimising electrode polarisation resistance through optimising the three functions whilst avoiding reactivity with the electrolyte and matching thermal expansion with other components of the fuel cell make the identification of a suitable cathode for the intermediate temperature range (500-700° C.) one of the key tasks for technological development.

One way to address this challenge is to investigate candidate cathodes with distinct domains within their structure. These distinct domains could in principle allow optimisation of each of the required functions. The perovskite structure has a very rich ordered defect chemistry leading to complex superstructures with multiple transition metal and A cation environments. C. Tenailleau, M. Allix, J. B. Claridge, M. Hervieu, M. F. Thomas, J. P. Hirst, M. J. Rosseinsky, J. Am. Chem. Soc. 440 (2008), 7570-7583 reported Ba₂Ca₂Nd₂Fe₆O_{15.6} with a perovskite superstructure of high structural complexity featuring three distinct environments for both A and B-site cations. This offers interesting perspectives in the interplay between A-site order, oxygen content and transition metal oxidation state and environment. The A-site order leads to anion vacancy ordering and results in multiple transition metal coordination environments. The structure consists of ten repeat layers in the stacking direction and is therefore a promising one to consider from the point of view of SOFC cathodes. However the iron oxidation state is less than 3 and the oxide is therefore unsuitable for application in the SOFC cathode environment (>500° C. in air).

The present invention relates to a mixed barium-(calcium/strontium)-rare earth-transition metal oxide (eg barium-(calcium/strontium)-rare earth-iron oxide) exhibiting perovskite-type structural characteristics (ie a perovskite structural motif) which is stable under ambient oxygen pressure conditions over a wide temperature range and exhibits a desirably low area specific resistance (ASR) competitive with the best known cathodic materials.

Thus viewed from a first aspect the present invention provides a mixed metal oxide exhibiting perovskite-type structural characteristics in which there are cations of:

Ba;

X, wherein X denotes Ca or Sr;

Z, wherein Z denotes a rare earth metal; and

T, wherein T denotes Fe, Cr, Cu, Co or Mn and is present in three different coordination sites,

wherein one or more of the cations is optionally partially substituted by a metal dopant,
or a composition thereof.

The mixed metal oxide of the invention is stable in air at temperatures in the range 25 to 900° C. and maintains structural integrity. The stability permits the exploitation of cathodic behaviour which is surprisingly good in spite of the high dc resistance produced by the integer charge T composition. These advantages together with advantages such as chemical compatibility with electrolytes (such as lanthanide-doped cerium dioxide electrolytes), stability in highly reducing conditions and in CO₂ at a range of high temperatures and a desirable thermal expansion coefficient provides an unprecedented combination of properties which make the mixed metal oxide of the invention an excellent cathode for use in a solid oxide fuel cell.

Preferably the three different coordination sites include a substantially square pyramidal coordination site. Particularly preferably the three different coordination sites are substantially octahedral, square pyramidal and tetrahedral.

The occupancy of square-based pyramidal sites by T may enhance the role of these sites at the surface in the adsorption of oxygen molecules and subsequent dissociation. Such considerations may contribute to the low activation energy found for the oxygen reduction reaction (ORR) process.

In a preferred embodiment, T is Fe or Co. Particularly preferably T is Fe.

The perovskite-type structural characteristics may be attributable to a perovskite structure, a double perovskite structure, a perovskite superstructure, a Ruddlesden-Popper structure or a brownmillerite structure.

Preferably the perovskite-type structural characteristics are attributable to a perovskite superstructure. Particularly preferably the perovskite superstructure is indexable on a unit cell with a volume which is 5 or more times the volume of the perovskite unit cell, more preferably 10 or more times the volume of the perovskite unit cell, especially preferably 15 or more times the volume of the perovskite unit cell, more preferably 20 or more times the volume of the perovskite unit cell, even more preferably 32 or more times the volume of the perovskite unit cell.

Preferably the perovskite-type structural characteristics are attributable to a layered perovskite structure. Particularly preferably the layered perovskite structure has 5 or more layers, more preferably 8 or more layers, especially preferably 10 or more layers, more especially preferably 16 or more layers.

The structure of the mixed metal oxide may be an intergrowth structure (eg a layer, block or slab intergrowth structure). The intergrowth structure may be a partial, substantially ordered or disordered intergrowth structure. In a preferred embodiment, the mixed metal oxide is structurally related to a 1:1 intergrowth of X₂T₂O₅ and ZBa₂T₃O₈.

The structure of the mixed metal oxide may feature one or more twelve coordinate (eg substantially cubooctahedral) sites. The structure of the mixed metal oxide may feature one or more eight coordinate sites. The structure of the mixed metal oxide may feature one or more nine coordinate sites.

Preferably the structure of the mixed metal oxide features twelve coordinate (eg substantially cubooctahedral), nine coordinate and eight coordinate sites. Typically the occupancy of the twelve coordinate (eg cubooctahedral), nine coordinate and eight coordinate sites is substantially ordered.

Ba is typically located preferentially (eg substantially exclusively) on a twelve coordinate site. Typically the twelve coordinate site is occupied predominantly by Ba. For example, 90% or more of the occupied twelve coordinate sites may be occupied by Ba.

Typically the nine coordinate site is occupied predominantly by X (eg calcium).

Typically the eight coordinate site is occupied by Z (eg yttrium) and X (eg calcium), preferably predominantly by Z.

Preferably the perovskite-type structural characteristics are attributable to a structure with an asymmetric crystallographic unit of chemical formula:

A₅B₅O_{13±δ}

wherein:

A denotes a site occupied predominantly by Ba, X and Z;

B denotes a site occupied predominantly by T; and

δ denotes optional oxygen non-stoichiometry.

In this embodiment the structure may feature twelve coordinate (eg cubooctahedral), nine coordinate and eight coordinate A-sites. Typically the occupancy of the A-sites is substantially ordered.

Barium is typically located substantially exclusively on the twelve coordinate A-site. Typically the twelve coordinate A-site is occupied predominantly by barium. For example, Ba may occupy 90% or more of the twelve coordinate A-sites which are occupied by Ba in an ideal intergrowth structure.

Typically the nine coordinate A-site is occupied predominantly by X (eg calcium). For example, X may occupy 80% or more of the nine coordinate A-sites which are occupied by X in an ideal intergrowth structure.

Typically the eight coordinate A-site is occupied by Z (eg yttrium) and X (eg calcium), preferably predominantly by Z. For example, Z may occupy 66% or more of the eight coordinate A-sites which are occupied by Z in an ideal intergrowth structure.

The mixed metal oxide may additionally exhibit rock salt-type structural characteristics.

Alternatively preferably the perovskite-type structural characteristics are attributable to a structure with an asymmetric crystallographic unit of chemical formula:

A₈B₈O_{21±δ}

wherein:

A denotes a site occupied predominantly by Ba, X and Z;

B denotes a site occupied predominantly by T; and

δ denotes optional oxygen non-stoichiometry.

In this embodiment the structure may feature twelve coordinate (eg cubooctahedral) and multiple eight coordinate A-sites. Typically the occupancy of the A-sites is substantially ordered.

Barium is preferentially located on the twelve coordinate A-site. Typically the twelve coordinate A-site is occupied by barium and Z.

Z (eg yttrium) is preferentially located on the twelve coordinate A-site and an eight coordinate A site.

X (eg calcium) is preferentially located on 2 eight coordinate A-sites.

The rare earth metal Z may be a lanthanide or Y (yttrium). The rare earth metal Z may be La, Sm, Gd, Y, Ho, Er, Tm or Dy, preferably La, Sm, Gd, Y or Dy, particularly preferably Gd, Sm, Y or Dy, more preferably Y.

Preferably X denotes Ca.

Preferably the mixed metal oxide has a structural unit of formula:

Ba_{y}XₓZ_{z}TₙO_{13±δ}

wherein:

X, Z and T are as hereinbefore defined;

y is in the range 1.0 to 3.0;

x is in the range 1.0 to 3.0;

z is in the range 0.5 to 2.0;

x+y+z is in the range 4.9 to 5.1;

n is in the range 4.9 to 5.1; and

δ denotes optional oxygen non-stoichiometry,

wherein one or more of Ba, X, Z and T is optionally partially substituted by a metal dopant.

Preferably y is in the range 1.4 to 2.0, particularly preferably 1.5 to 1.7.

Preferably x is in the range 2.0 to 2.5, particularly preferably 2.2 to 2.4.

Preferably z is in the range 0.8 to 1.3, particularly preferably 1.0 to 1.2.

Preferably n is 5.

A preferred mixed metal oxide has a structural unit of formula Ba_{1.6}X_{2.3}Z_{1.1}T₅O₁₃. A particularly preferred mixed metal oxide has a structural unit of formula Ba_{1.6}X_{2.3}Y_{1.1}Fe₅O₁₃ or Ba_{1.6}Ca_{2.3}Z_{1.1}Fe₅O₁₃. An especially preferred mixed metal oxide has a structural unit of formula Ba_{1.6}Ca_{2.3}Y_{1.1}Fe₅O₁₃Ba_{1.6}Ca_{2.3}Y_{1.1}Fe₅O₁₃ has an unusually large layered perovskite structure which is indexable on a unit cell having a volume 20 times the volume of the perovskite unit cell and is stable in an ambient atmosphere. Structural ordering facilitates the presence of oxygen deficient layers over the useful temperature range 25 to 900° C.

Alternatively preferably the mixed metal oxide has a structural unit of formula:

BaₚX_{q}ZᵣTₛO_{21±δ}

wherein:

X, Z and T are as hereinbefore defined;

p is in the range 1.0 to 3.0;

q is in the range 3.0 to 4.0;

r is in the range 2.0 to 3.0;

p+q+r is in the range 7.9 to 8.1;

s is in the range 7.9 to 8.1; and

δ denotes optional oxygen non-stoichiometry,

wherein one or more of Ba, X, Z and T is optionally partially substituted by a metal dopant.

Preferably p is in the range 1.9 to 2.5, particularly preferably 2.1 to 2.3.

Preferably q is in the range 3.2 to 3.8, particularly preferably 3.4 to 3.6.

Preferably r is in the range 1.8 to 2.8, particularly preferably 2.2 to 2.4.

Preferably s is 8.

A preferred mixed metal oxide has a structural unit of formula Ba_{2.2}X_{3.5}Z_{2.3}T₈O₂₁. A particularly preferred mixed metal oxide has a structural unit of formula Ba_{2.2}X_{3.5}Y_{2.3}Fe₈O₂₁, Ba_{2.2}Ca_{3.5}Y_{2.3}T₈O₂₁ or Ba_{2.2}Ca_{3.5}Z_{2.3}Fe₈O₂₁. An especially preferred mixed metal oxide has a structural unit of formula Ba_{2.2}Ca_{3.5}Y_{2.3}Fe_{7.4}Cu_{0.6}O₂₁ (eg Ba_{2.16}Ca_{3.52}Y_{2.32}Fe_{7.44}Cu_{0.56}O₂₁) Ba_{2.2}Ca_{3.5}Y_{2.3}Fe_{7.4}Cu_{0.6}O₂₁ has an unusually large layered perovskite structure which is indexable on a unit cell having a volume 32 times the volume of the perovskite unit cell

δ may denote zero (ie oxygen stoichiometry). In a preferred embodiment, S is non-zero and denotes an oxygen deficiency (ie oxygen present in the mixed metal oxide is non-stoichiometric). A desirable 30-fold increase in conductivity may be observed when a reduced oxygen partial pressure (10⁻²⁰ atm) is applied during preparation of the mixed metal oxide and the oxide remains structurally intact when returning to ambient pressure. In the case where T is Fe, this is attributable to the partial reduction of Fe³⁺ to Fe²⁺ allowing the presence of charge carriers which enhance conductivity whilst retaining structural stability. Furthermore a combination of good electronic conductivity with fast oxygen transport and stability under a wide range of temperature and oxygen partial pressure may result in good anodic behaviour in the SOFC field.

The mixed metal oxide may feature interstitial metal substitution.

Preferably one or more of Ba, X, Z and T is partially substituted by a metal dopant. Particularly preferably T is Fe and is partially substituted by a metal dopant.

The metal dopant for each substitution may be the same or different. The charge on the metal dopant may be the same or different from the charge on the Ba, X, Z or T which it substitutes. The (or each) metal dopant may be present in the substitution in an amount up to 40 at %, preferably up to 20 at %, particularly preferably up to 10 at %, more preferably up to 3 at %, most preferably up to 1 at %.

The metal dopant may be an A-site metal dopant. For example, the A-site metal dopant may substitute Ba. For example, the A-site metal dopant may substitute X. For example, the A-site metal dopant may substitute Z.

The metal dopant may be a twelve coordinate A-site metal dopant. The metal dopant may be a nine coordinate A-site metal dopant. The metal dopant may be an eight coordinate A-site metal dopant.

A preferred A-site metal dopant has an affinity for a twelve coordinate (eg cubooctahedral) site. A preferred A-site metal dopant has an affinity for an eight coordinate site. A preferred A-site metal dopant has an affinity for a nine coordinate site.

The metal dopant may be a B-site metal dopant. The metal dopant may be an octahedral B-site metal dopant. The metal dopant may be a square pyramidal B-site metal dopant. The metal dopant may be a tetrahedral B-site metal dopant.

A preferred metal dopant for T has an affinity for octahedral coordination. A preferred metal dopant for T has an affinity for square pyramidal coordination. A preferred metal dopant for T has an affinity for tetrahedral coordination.

A metal dopant for Fe may be Ti, Zr, Nb, Co, Cr, Cu, Mg, Mn, Mo, W, V, Ni or Zn, preferably Co, Cu, Mn, Mg or Zn. A particularly preferred metal dopant for Fe is Co. An alternative particularly preferred metal dopant for Fe is Cu.

A metal dopant for Ba may be Sr.

A metal dopant for X may be X′, wherein X and X′ are different and X′ is Ca or Sr.

Where X is Ca, X′ is preferably Sr.

A metal dopant for Z may be Z′, wherein Z and Z′ are different and Z′ is La, Sm, Gd, Y, Ho, Er, Tm or Dy, preferably La, Sm, Gd, Y or Dy, particularly preferably Gd, Sm, Y or Dy, more preferably Y.

Where Z is Y, Z′ is preferably La, Sm, Gd, Ho, Er, Tm or Dy, preferably La, Sm, Gd or Dy.

The mixed metal oxide may be present in a substantially monophasic or multiple phase composition (eg a binary or ternary phase composition). Preferably the mixed metal oxide is present in a substantially monophasic composition. Preferably the composition consists essentially of the mixed metal oxide. For example, the mixed metal oxide may be present in the composition in an amount of 50 wt % or more (eg in the range 50 to 99 wt %), preferably 75 wt % or more, particularly preferably 90 wt % or more, more preferably 95 wt % or more.

The composition may further comprise one or more perovskite phases. The (or each) perovskite phase may be present in the composition in an amount of 75 wt % or less, preferably 50 wt % or less, particularly preferably 25 wt % or less, more preferably 5 wt % or less. The (or each) perovskite phase may be present in a trace amount. Preferably the perovskite phase is BaFeO_{3-δ}.

The composition may comprise one or more non-perovskite phases. The non-perovskite phases may be mixed metal oxide phases of two or more (eg three) of Ba, X, Z or T. Examples include BaT₂O₄, X₂T₂O₅ (eg Ca₂Fe₂O₅) and Z₂O₃ (eg Y₂O₃). The amount of non-perovskite phases present in the composition may be such that the phases are non-discernible in an X-ray diffraction pattern. The amount of non-perovskite phases present in the composition may be a trace amount. Preferably the total amount of non-perovskite phases present in the composition is less than 10 wt %, particularly preferably less than 8 wt %, more preferably less than 5 wt %, yet more preferably less than 2 wt %, still yet more preferably less than 1 wt %, most preferably less than 0.1 wt %.

The mixed metal oxide composition may comprise one or more additives. The additive may be an oxide ion or electronic conductivity promoter. The promoter may be cerium dioxide which is preferably doped (eg lanthanide-doped). Preferred materials are samarium-doped cerium dioxide (eg Ce_{0.8}Sm_{0.2}O_{2-δ}) and gadolinium-doped cerium dioxide (eg Gd_{0.1}Ce_{0.9}O_{1.95}) The promoter may be an apatite or melilite compound.

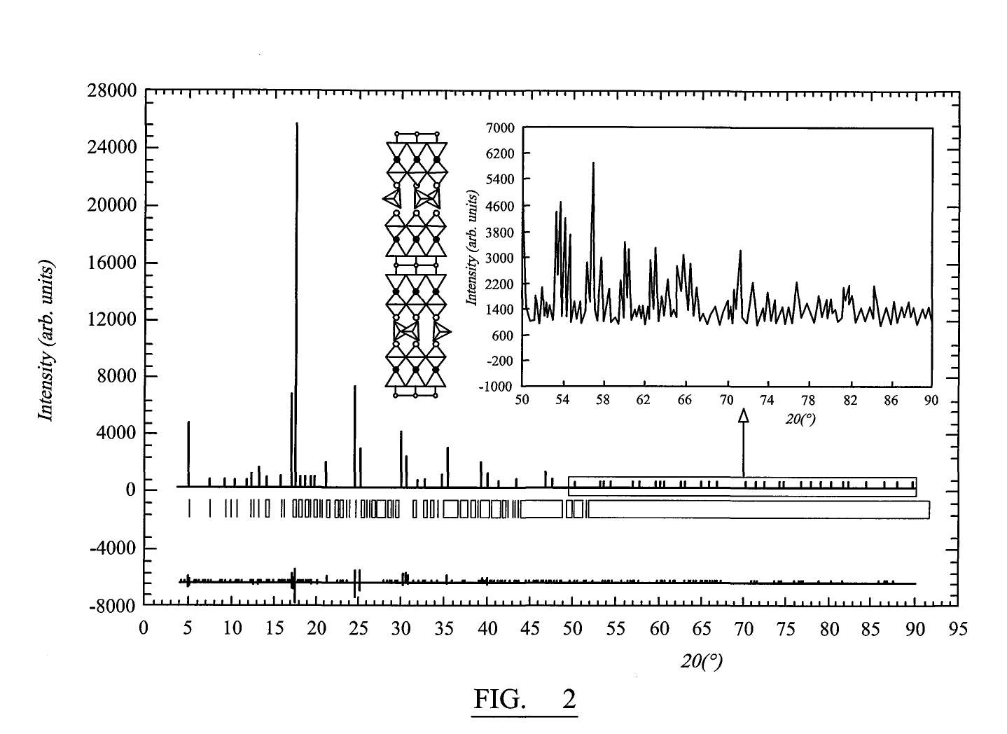

Preferably the mixed metal oxide (or composition thereof) has an X-ray diffraction pattern substantially as illustrated in FIG. 2.

The mixed metal oxides (or compositions thereof) of the invention may be prepared by a solid-state reaction of constituent metals in compound form (eg metal oxides, hydroxides, nitrates or carbonates) or of metal precursors formed by wet chemistry (eg sol-gel synthesis or metal co-precipitation). The mixed metal oxides (or compositions thereof) of the invention may be prepared by hydrothermal synthesis, combustion, freeze drying, aerosol techniques or spray drying.

The mixed metal oxides (or compositions thereof) of the invention may be in bulk or thin film form. Thin films may be prepared by screen printing, pulsed laser deposition, chemical vapour deposition, chemical solution deposition, atomic layer deposition, sputtering or physical vapour deposition. The mixed metal oxide (or composition thereof) of the invention may be a membrane.

In a preferred embodiment, the mixed metal oxide or composition thereof is obtainable by a process comprising:
(A) preparing an intimate mixture of a substantially stoichiometric amount of a compound of each of Ba, X, Z and T; and
(B) inducing a reaction in the intimate mixture to produce the mixed metal oxide or composition thereof.

Preferably the substantially stoichiometric amount of the compound of each of Ba, X, Z and T gives a cationic ratio of a:b:c:d, wherein:
a is in the range 1.6 to 2.2;
b is in the range 1.8 to 2.8;
c is in the range 0.2 to 1.2;
a+b+c is 5; and
d is 5.

Preferably a is in the range 1.7 to 2.0 (eg about 1.7).

Preferably b is in the range 2.0 to 2.6, particularly preferably 2.3 to 2.5 (eg about 2.4).

Preferably c is in the range 0.8 to 1.1, particularly preferably 0.9 to 1.1 (eg about 0.9).

Alternatively preferably the substantially stoichiometric amount of the compound of each of Ba, X, Z and T gives a cationic ratio of a′:b′:c′:d′, wherein:
a′ is in the range 2.1 to 2.6;
b′ is in the range 3.1 to 3.7;
c′ is in the range 2.0 to 2.5;
a′+b′+c′ is 8; and
d′ is 8.

Preferably a′ is in the range 2.2 to 2.4 (eg about 2.3).

Preferably b′ is in the range 3.3 to 3.5 (eg about 3.4).

Preferably c′ is in the range 2.1 to 2.3 (eg about 2.2).

Viewed from a further aspect the present invention provides a process for preparing a mixed metal oxide or a composition thereof as hereinbefore defined comprising:
(A) preparing an intimate mixture of a substantially stoichiometric amount of a compound of each of Ba, X, Z, T and the optional metal dopant; and
(B) inducing a reaction in the intimate mixture to produce the mixed metal oxide or composition thereof.

The intimate mixture in step (A) may include a compound (eg oxide) of a metal dopant as hereinbefore defined.

The compound of each of Ba, X, Z and T may be independently selected from the group consisting of an oxide, nitrate, hydroxide, hydrogen carbonate, isopropoxide, polymer and carbonate, preferably an oxide and carbonate. Examples are Z₂O₃, BaCO₃, XCO₃ and T₂O₃.

The intimate mixture may be a powder, slurry (eg a milled slurry), a solution (eg an aqueous solution), a suspension, a dispersion, a sol-gel or a molten flux.

Step (B) may include heating (eg incremental, stepwise or interval heating) and optionally interval cooling. Step (B) may be cyclical. For example, step (B) may include cycles of heating and grinding.

The process may further comprise: a post-treatment step. The post-treatment step may be a post-annealing (eg rapid thermal post-annealing) step, oxidizing step or reducing step. Post-annealing may be carried out at a temperature in the range 500° C. to 1200 C for an annealing period of a few seconds to 60 minutes in an air flow.

The mixed metal oxide (or composition thereof) may be formulated into an ink. The ink may include an organic binder.

Preferably the substantially stoichiometric amount of the compound of each of Ba, X, Z and T gives a cationic ratio of a:b:c:d, wherein:
a is in the range 1.6 to 2.2;
b is in the range 1.8 to 2.8;
c is in the range 0.2 to 1.2;
a+b+c is 5; and
d is 5.

Preferably a is in the range 1.7 to 2.0 (eg about 1.7).

Preferably b is in the range 2.0 to 2.6, particularly preferably 2.3 to 2.5 (eg about 2.4).

Preferably c is in the range 0.8 to 1.1, particularly preferably 0.9 to 1.1 (eg about 0.9).

Alternatively preferably the substantially stoichiometric amount of the compound of each of Ba, X, Z and T gives a cationic ratio of a′:b′:c′:d′, wherein:
a′ is in the range 2.1 to 2.6;
b′ is in the range 3.1 to 3.7;
c′ is in the range 2.0 to 2.5;
a′+b′+c′ is 8; and
d′ is 8.

Preferably a′ is in the range 2.2 to 2.4 (eg about 2.3).

Preferably b′ is in the range 3.3 to 3.5 (eg about 3.4).

Preferably c′ is in the range 2.1 to 2.3 (eg about 2.2).

Preferably the mixed metal oxide or composition thereof is stable (eg maintains structural integrity) in air (eg stable in air at temperatures in the range 25 to 900° C.).

Viewed from a yet further aspect the present invention provides the use of a mixed metal oxide or a composition thereof as hereinbefore defined as a cathode.

Preferably in the use according to the invention the cathode is operable at a temperature in excess of 500° C., particularly preferably at a temperature in the range 500° C. to 750° C.

Preferably the cathode is electron conducting. Preferably the cathode is oxide ion conducting.

Viewed from a yet still further aspect the present invention provides a solid oxide fuel cell comprising a cathode as hereinbefore defined, an anode and an oxygen-ion conducting electrolyte.

Typically the electrolyte is a ceramic electrolyte. The electrolyte may be yttria stabilised zirconia, a lanthanide-doped cerium dioxide such as samarium-doped cerium dioxide (eg Ce_{0.8}Sm_{0.2}O_{2-δ}), gadolinium-doped cerium dioxide (eg Gd_{0.1}Ce_{0.9}O_{1.95}) or a doped lanthanum gallate composition such as La₁₋ₓSrₓGa_{1-y}Mg_{y}O_{3-d}. The mixed metal oxide of the invention is usefully compatible chemically with lanthanide-doped cerium dioxide at high temperature.

The electrolyte may be sandwiched between the anode and cathode. The solid oxide fuel cell may be symmetric or asymmetric. The solid oxide fuel cell may comprise intermediate or buffer layers.

For Ba_{1.6}Ca_{2.3}Y_{1.1}Fe₅O₁₃, the area specific resistance observed in a symmetrical cell with the samarium-doped cerium dioxide electrolyte is 0.87 Ω.cm² at 700° C. which is comparable with the best known materials. This is attributable to the unique structural feature of the square pyramidal Fe³⁺ layer favouring oxide ion formation and mobility which is sufficient to overcome the limitations of low electronic conductivity to provide an excellent cathode. Furthermore preliminary processing tests performed by varying processing conditions and the sintering temperature of the symmetrical cell showed that the ASR can be decreased below 0.1 Ω.cm² at 750° C. and it can be decreased to 0.05 Ω.cm² at 800° C. These highly promising results emphasize the relevance of the material as an SOFC cathode whilst suggesting that further improvements in powder processing and optimisation of cell fabrication may easily decrease the ASR further.

The increased DC conductivity in reducing environments also indicates that the mixed metal oxide of the invention may be a useful anode.

Viewed from a still yet further aspect the present invention provides the use of a mixed metal oxide or composition thereof as hereinbefore defined as an anode.

Fast oxygen dissociation and bulk oxide diffusion makes the mixed metal oxide of the invention relevant in the field of gas separation.

Viewed from an even yet still further aspect the present invention provides the use of a mixed metal oxide or composition thereof as hereinbefore defined as a gas separation membrane.

The membrane may have applications in air separation or in a catalytic reactor.

Viewed from a yet still further aspect the present invention provides a cathode or anode composed of a mixed metal oxide or composition thereof as hereinbefore defined.

Viewed from a still yet further aspect the present invention provides the use of a mixed metal oxide or a composition thereof or a cathode or an anode as hereinbefore defined in a solid oxide fuel cell or a solid oxide electrolyser cell (SOEC).

The present invention recognises that a structure with three distinct coordination sites for T (eg Fe) could be achieved with two cations.

Thus viewed from a further aspect the present invention provides a mixed metal oxide exhibiting perovskite-type structural characteristics in which there are cations of:

Ba;

one of X or Z, wherein X and Z are as hereinbefore defined; and

T, wherein T is as hereinbefore defined and is present in three different coordination sites,

wherein one or more of the cations is optionally partially substituted by a metal dopant

wherein the perovskite-type structural characteristics are attributable to a layered perovskite superstructure indexable on a unit cell with a volume which is 5 or more times the volume of the perovskite unit cell,

or a composition thereof.

One of X or Z in this aspect of the invention may be one of X or Z as they are disclosed hereinbefore generally or specifically.

One of X or Z may be strontium, calcium or yttrium.

In a preferred embodiment of this aspect of the invention, one of X or Z is yttrium.

In a preferred embodiment of this aspect of the invention, one of X or Z is calcium.

T in this aspect of the invention may be T as it is disclosed hereinbefore generally or specifically. Preferably T is Fe.

Preferably in this aspect of the invention the layered perovskite superstructure is indexable on a unit cell with a volume which is 10 or more times the volume of the perovskite unit cell, particularly preferably 15 or more times the volume of the perovskite unit cell, more preferably 20 or more times the volume of the perovskite unit cell, even more preferably 32 or more times the volume of the perovskite unit cell.

Preferably in this aspect of the invention the layered perovskite superstructure has 5 or more layers, particularly preferably 8 or more layers, especially preferably 10 or more layers, more especially preferably 16 or more layers.

The present invention will now be described in a non-limitative sense with reference to Examples and the following Figures:

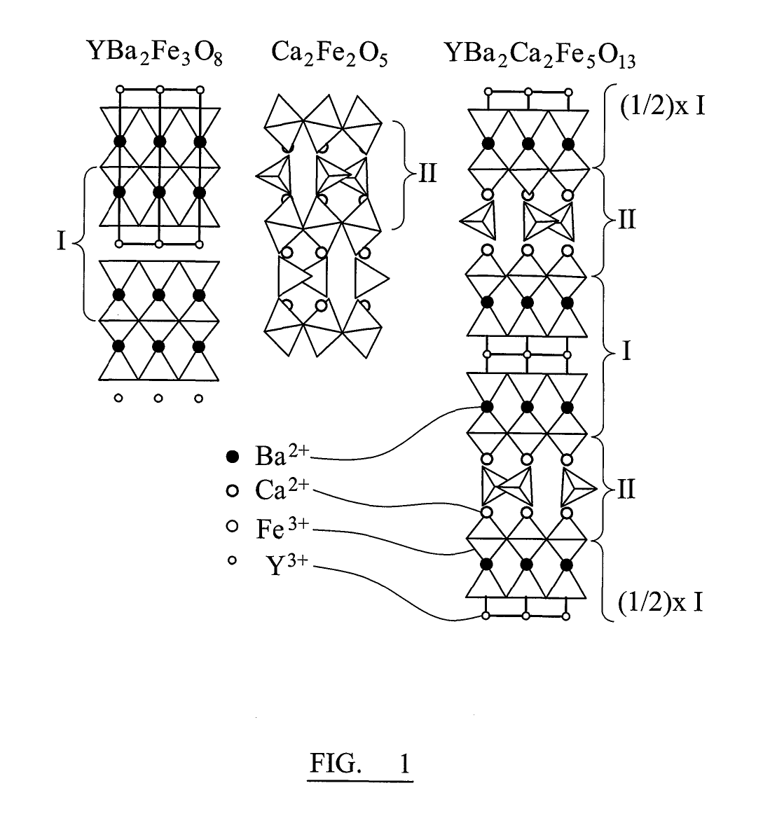

FIG. 1: Structures of YBa₂Fe₃O₈, Ca₂Fe₂O₅ and of the ideal ten layer intergrowth YBa₂Ca₂Fe₅O₁₃. Building units I and II (marked by brackets) of YBa₂Fe₃O₈ and Ca₂Fe₂O₅ are regularly stacked in a 1:1 ratio;

FIG. 2: Rietveld refinement of the powder synchrotron X-ray diffraction data from Ba_{1.6}Ca_{2.3}Y_{1.1}Fe₅O₁₃ at room temperature;

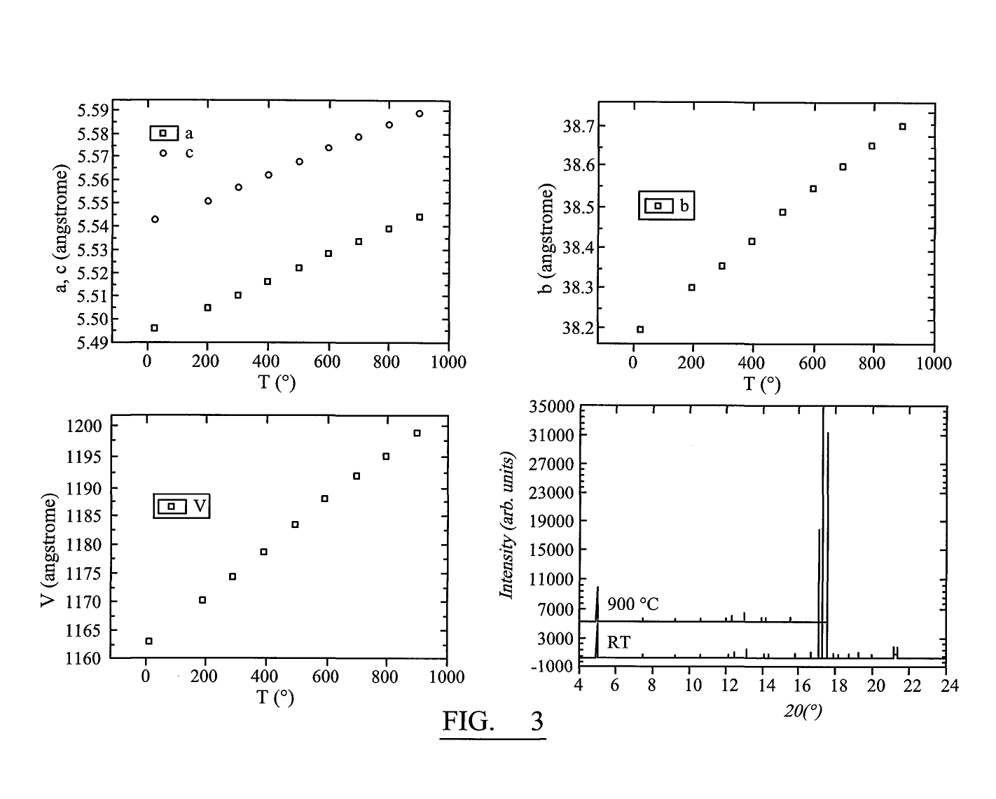

FIG. 3: Evolution of the unit cell parameters of Ba_{1.6}Ca_{2.3}Y_{1.1}Fe₅O₁₃ as a function of temperature;

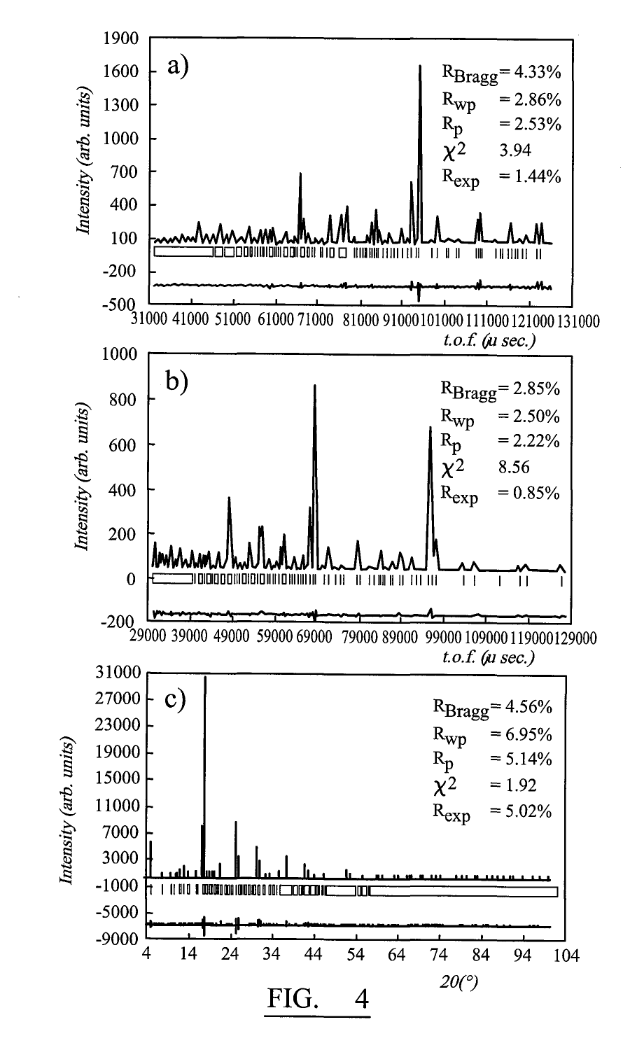

FIG. 4: Combined X-ray and neutron refinements of Ba_{1.6}Ca_{2.3}Y_{1.1}Fe₅O₁₃ at 485° C. and 500° C. respectively a) neutron backscattering bank, b) neutron 90° bank and c) synchrotron X-rays;

FIG. 5: Structure of Ba_{1.6}Ca_{2.3}Y_{1.1}Fe₅O₁₃ showing the composition of the rock salt layers where the combined refinement leads to a total A-site composition of Ba_{1.9}Ca_{2.1}Y;

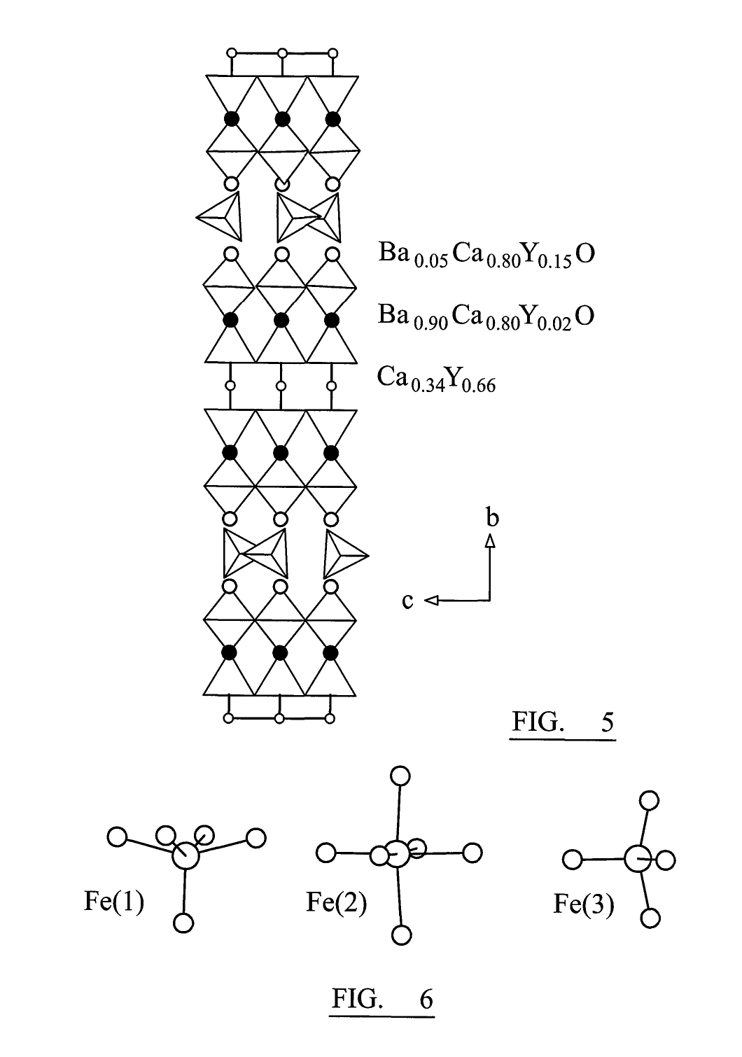

FIG. 6: Iron polyhedra deduced from the combined refinement of Ba_{1.6}Ca_{2.3}Y_{1.1}Fe₅O₁₃;

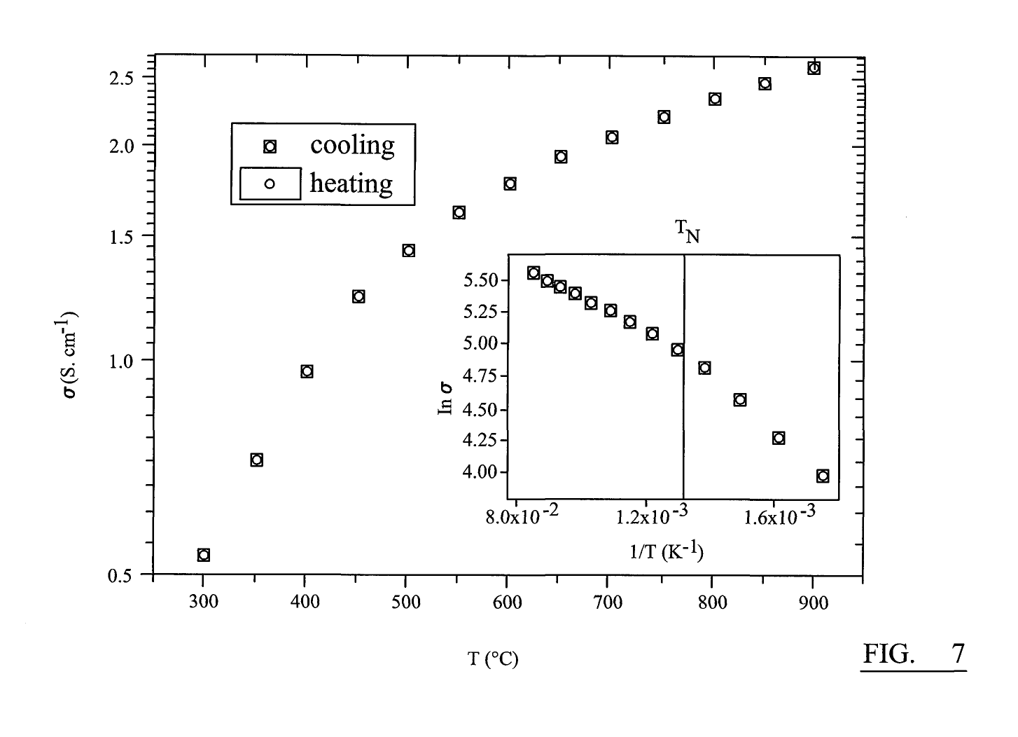

FIG. 7: DC conductivity of Ba_{1.6}Ca_{2.3}Y_{1.1}Fe₅O₁₃ collected upon heating and cooling. Dashed line on the inserted lnσ=f(1/T) curve marks the Neel transition temperature;

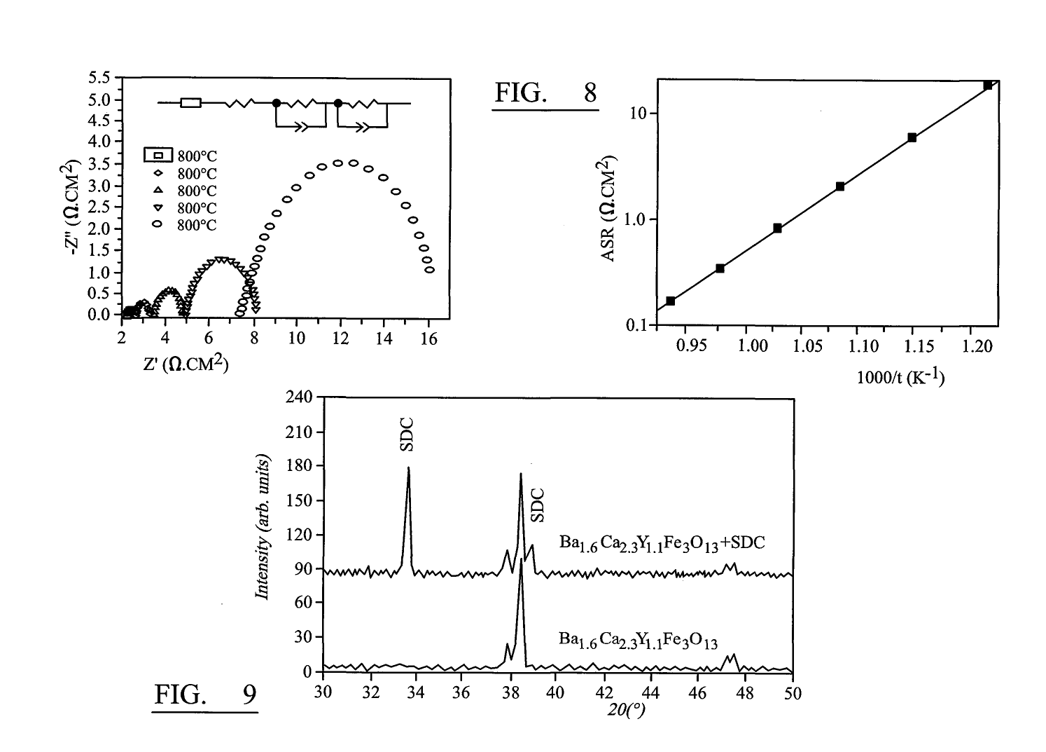

FIG. 8: AC impedance spectroscopy and ASR plot for the symmetrical cell Ba_{1.6}Ca_{2.3}Y_{1.1}Fe₅O₁₃/SDC/Ba_{1.6}Ca_{2.3}Y_{1.1}Fe₅O₁₃;

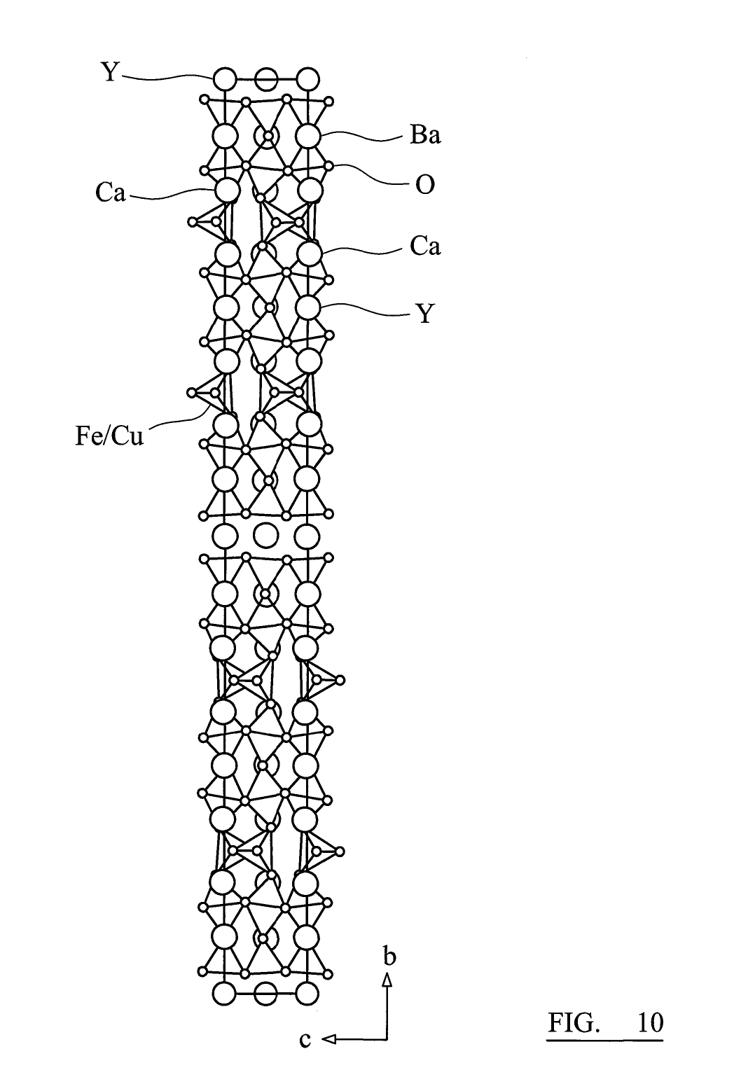

FIG. 9: Chemical compatibility tests with SDC electrolyte showing (from top to bottom) the single phase ten layer material PXD pattern and the resulting PXD pattern of the ten layer material annealed at 1150° C. for 12 h in the presence of SDC electrolyte; and

FIG. 10: Crystal structure of Y_{2.24}Ba_{2.28}Ca_{3.48}Fe_{7.44}Cu_{0.56}O_{21±δ}. The unit cell is shown.

### EXAMPLE

### Experimental

Polycrystalline samples were prepared by direct reaction of Y₂O₃, BaCO₃, CaCO₃ and Fe₂O₃ at 1200° C. in alumina crucibles under ambient air atmosphere with compositions having the cationic ratios listed in Table SI1.

TABLE SI1
Cationic compositions tested during synthesis

| Ba | Ca | Y | Fe |
|---|---|---|---|
| 2 | 2 | 1 | 5 |
| 2 | 2.25 | 0.75 | 5 |
| 2 | 2.5 | 0.5 | 5 |
| 2 | 2.75 | 0.25 | 5 |
| 1.81 | 2.32 | 0.87 | 5 |
| 1.7 | 2.4 | 0.9 | 5 |
| 1.6 | 2.5 | 0.9 | 5 |
| 1.7 | 2.5 | 0.8 | 5 |
| 1.6 | 2.6 | 0.8 | 5 |
| 1.7 | 2.3 | 1 | 5 |

The heating and cooling rates were respectively 5 and 3°/mn while the heating time was 12 h. Several cycles of regrinding and firing were generally performed to ensure phase homogeneity and complete the reaction process. With the appropriate metal ratios described in the Results section below, three of these cycles could reproducibly produce a 5 g single phase sample. Phase identification and purity were examined by powder X-ray diffraction collected on a Panalytical system using Co Kα₁ radiation in Bragg-Brentano geometry. Thermogravimetric analysis (TGA) was performed using a TA instruments Q600 thermal analyzer.

Crystal structure analysis was carried out by powder X-ray diffraction and powder neutron diffraction. The X-ray experiment took place at station I11 of the Diamond Light Source over a 2θ range of 2.836 to 141.970° (π=0.82678 Å). Data were collected at room temperature and from 100° C. to 900° C. with a step of 100° C. High resolution neutron powder diffraction data were collected on the HRPD beamline at ISIS Rutherford Appleton laboratory. Data were initially collected for 3 h at room temperature then 5 minute scans were performed at 450, 475, 480 and 485° C. At the latter temperature, magnetic ordering peaks were not observed and data were collected for a further 3 h. Structural parameters were refined by the Rietveld method using the software FULLPROF included in the WINPLOTR package (J. Rodriguez-Carvajal, Fullprof, in: J. Galy (Ed.), Collected abstracts of powder diffraction meeting, Toulouse, France, p. 127). Bond valence sums were calculated according to I. D. Brown, D. Alternatt, Acta Cryst. B41 (1985), 244-247.

DC conductivity data were collected by the standard four-probe method on a bar with approximate dimensions of 2×2×10 mm³. Pt paste was used to bond the Pt wires in a four-in-a-line contact geometry. In order to limit the grain boundary contribution to the measurement, the material was processed to obtain a dense object. An as-made Ba_{1.6}Ca_{2.3}Y_{1.1}Fe₅O₁₃ single phase sample was introduced into a FRITSCH Pulverizette 7 classic instrument and ball-milled for 48 h in ethanol. The resulting fine powder was mixed with a 2% polyvinyl alcohol (PVA) solution in water before being dried overnight. The PVA mass fraction was adjusted to 3% of the total sample mass. The sample was then pressed into a pellet via cold-isostatic pressing (CIP) with 200 MPa pressure and the final step of the synthesis was then repeated with an extended heating time of 24 h at 1200° C. Pellets obtained by this procedure were of a theoretical density >90%. Phase purity was checked before and after the dc conductivity measurement by PXD.

Chemical compatibility tests between the cathode and the electrolytes samarium doped cerium dioxide (SDC, Ce_{0.8}Sm_{0.2}O₂) and yttrium stabilized zirconia (YSZ, 8 mol % Y₂O₃-doped ZrO₂) were carried out. The material and electrolyte were mixed with a weight ratio of 1:1, pressed into pellets and fired at 1150° C. for 12 h before the resulting sample was analysed by powder X-ray diffraction. A symmetrical cell composed of Ba_{1.6}Ca_{2.3}Y_{1.1}Fe₅O₁₃/SDC/Ba_{1.6}Ca_{2.3}Y_{1.1}Fe₅O₁₃ was formulated. Dense (>98% theoretical density) single phase pellets of SDC were obtained by uniaxial and isopressing commercial powder (Fuel Cell Materials) into green pellets followed by sintering at 1400° C. for 5 hours. The SDC surface was polished with SiC paper to obtain a flat surface prior to screen printing with the cathode ink. The ink was formulated from Ba_{1.6}Ca_{2.3}Y_{1.1}Fe₅O₁₃ powder mixed by ball-milling with an organic binder (Heraeus V006) which was screen printed onto both surfaces of the cylindrical SDC electrolyte. Adherence of the ink to the SDC surface was achieved after calcining at 1150° C. for 3 hours in air. Gold gauze fixed with gold paste was used as current collection for the electrical measurement. AC impedance spectroscopy was performed on the symmetrical cell over a frequency range of 1 MHz to 0.1 Hz using a Solartron 1260 FRA with a modulation potential of 10 mV over the temperature range of 873 to 1073K in static air. Measurements were made using ZPlot v.2.9b (Scribner Associates) and equivalent circuit modelling was performed using ZView v.2.8 (Scribner Associates). The area specific resistance (ASR) of the cathode was calculated by normalising the measured resistance for the electrode area and dividing by two to take into account the symmetry of the cell.

### Results

### Isolation of the Compound

Initial attempts to synthesise the ten layer perovskite were aimed at an ideal intergrowth between Ca₂Fe₂O₅ brownmillerite and YBa₂Fe₃O₈ with stoichiometric amounts of BaCO₃, CaCO₃, Y₂O₃ and Fe₂O₃ adjusting the cationic ratio to a Ba₂Ca₂YFe₅ composition. Firing at 1200° C. led to the observation of a low angle peak at dₕₖₗ≈9.5 Å in the powder X-ray diffraction pattern which was assigned to a phase with long crystalline periodicity. Referring to previously reported Ba₂Ca₂Nd₂Fe₆O_{15.6}, the majority of diffraction peaks could be indexed on the basis of an orthorhombic perovskite superstructure with the unit cell aₚ√2×10aₚ×aₚ√2 in the Imma space group. The main impurity was BaFeO_{3-δ} which still remained after several cycles of regrinding and firing. This prompted an EDS study to determine the main phase composition before possible modification of synthesis conditions. The EDS study was performed on twenty crystals of the targeted phase which revealed an average cation content of Ba_{1.81}Ca_{2.32}Y_{0.87} on the A-site and syntheses were targetted at this Ba, Y-deficient and Ca excess composition range.

The Ba_{4.7}Ca_{2.4}Y_{0.9}Fe₅ nominal stoichiometry allowed a single phase sample to be obtained in a reproducible way with a powder X-ray diffraction pattern totally indexed by the aforementioned crystallographic unit cell characteristic of a large perovskite superstructure. The material could only be isolated reproducibly for this cation content under ambient conditions which suggested a narrow (if not fixed) range of composition under the synthesis conditions. Hence samples with A-site compositions of the form Ba_{1.7+x}Ca_{2.4-y}Y_{0.9-z}, Ba_{1.7-y}Ca_{2.4+x}Y_{0.9-z}, Ba_{1.7-z}Ca_{2.4-y}Y_{0.9+x} (x, y, z>0; x=y+z) repeatedly led respectively to the observation of BaFeO_{3-δ} or BaFe₂O₄, Ca₂Fe₂O₅ and Y₂O₃ secondary phases. Finally EDS performed on a 5 g sample preparation dedicated to the powder neutron diffraction experiment gave the composition Ba_{1.62}Ca_{2.32}Y_{1.06}Fe_{5.10} with up to 0.2 variations being observed on these formula unit numbers from one crystallite to another

### Structural Analysis

Room temperature synchrotron powder X-ray diffraction was initially performed to study the crystal structure of the new material. The unit cell indexing and phase purity were initially confirmed with LeBail fits using a pseudo-Voigt peak shape giving χ²=1.81. Then a Ba₂Ca₂Nd₂Fe₆O_{15.6} ten layer type model was introduced and cell parameters, atomic positions and isotropic thermal factors were refined. Final reliability factors were R_{Bragg}=4.19%, Rₚ=5.39%, R_{wp}=6.99%, χ²=2.37 for Rₑₓₚ=4.54%. The final calculated, observed and difference curves are presented in FIG. 2 while structural parameters are summarized in Table SI2.

Although A-site ordering cannot be fully determined by X-ray diffraction alone and requires the use of combined analysis, Fourier observed maps clearly showed strong discrepancies in electron densities on the A-site scattering centers. Refinement in terms of Ba²⁺ fractional occupancy (to estimate electron density on each A-site) leads to 0.517(2), 0.410(2), 0.907 (3) for the 8, 9 and 12 coordinate sites respectively (Table SI2).

TABLE SI2
Structural parameters from the refinement of synchrotron
X-ray diffraction data

| Atom | site | x | y | z | Bᵢₛₒ (Å²) | Occ. |
|---|---|---|---|---|---|---|
| Fe1 | 8h | 0.00000 | 0.04933 (4) | 0.5027 (6) | 0.32 (3) | 8.000 |
| Fe2 | 8h | 0.00000 | 0.15279 (4) | 0.5037 (6) | 0.42 (3) | 8.000 |
| Fe3 | 8i | 0.0553 (7) | 0.25000 | 0.5733 (6) | 0.77 (7) | 4.000 |
| Ba1 (Y) | 4a | 0.00000 | 0.00000 | 0.00000 | 0.84 (5) | 2.067 (9) |
| Ba2 (Ba) | 8h | 0.00000 | 0.59964 (2) | −0.0043 (3) | 0.63 (2) | 7.25 (3) |
| Ba3 (Ca) | 8h | 0.00000 | 0.69344 (3) | −0.0246 (5) | 1.05 (4) | 3.28 (2) |
| O1 | 8g | 0.25000 | 0.0388 (3) | 0.25000 | 0.53 (3) | 8.000 |
| O2 | 8g | 0.25000 | 0.9646 (3) | 0.25000 | 0.9 (3) | 8.000 |
| O3 | 8g | 0.25000 | 0.1504 (3) | 0.25000 | 0.1 (2) | 8.000 |
| O4 | 8g | 0.25000 | 0.6577 (3) | 0.25000 | 0.5 (2) | 8.000 |
| O5 | 8i | 0.390 (3) | 0.25000 | 0.617 (3) | 0.8 (4) | 4.000 |
| O6 | 8g | 0.00000 | 0.0983 (2) | 0.514 (2) | 1.1 (2) | 8.000 |
| O7 | 8g | 0.00000 | 0.2068 (3) | 0.425 (2) | 1.6 (3) | 8.000 |

Space group: Imma, a = 5.49654(3)Å, b = 38.2017(3)Å, c = 5.54373(3)Å R_{Bragg} = 4.19%, Rₚ = 5.39%, R_{wp} = 6.99%, χ² = 2.37, for a Rₑₓₚ = 4.54%

These analyses confirmed a ten layer perovskite stacking with oxygen vacancy ordering generating three types of iron environments in layers along the b axis, namely tetrahedral, square based pyramidal and octahedral environments in respective ratios 1:2:2 with bond valence sum calculations leading to 2.87, 2.79 and 3.15 (notably close to Fe³⁺). Extra oxygen was detected neither in the tetrahedral layer nor in the apical vacant site that results in the square based pyramid coordination. When forcing an oxygen position into this 0 0½ site, occupancy was refined to a value of −0.013.

Three distinct A-sites were also observed with coordination numbers of 8, 9 and 12 in respective ratios 1:2:2. At this stage Ba, Ca and Y occupancies on each of these sites could not be refined due to a lack of information and combined X-ray/neutron analysis was needed to discuss their ordering in the crystal structure. However estimation of the scattering intensity in terms of barium fractional occupancy led to the different values of 0.517(2), 0.410(2), 0.907 (3) for the 8, 9 and 12 coordinated sites respectively. This could clearly be seen in Fourier observed maps of the unit cell suggesting a preferential ordering of A-site cations in the different rock salt layers occurring along the stacking axis b.

Powder X-ray diffraction patterns were collected up to 900° C. (after which the material reacts with the quartz capillary) with a step of 100° C. to evaluate possible structural changes over this temperature range (see FIG. 3). Except for the thermal expansion and broadening of peaks, the 900° C. pattern showed a striking similarity with the room temperature one and the a, b and c parameters undergo a linear increase upon heating. An anisotropic thermal expansion was observed, namely while a and c parameters nearly follow a parallel evolution, the long b axis increases almost twice as rapidly suggesting that the different successive layers tend to constrain each other in the basal plane (ac) while relaxing more easily along the stacking axis b. This anisotropic thermal expansion between the basal plane and stacking axis is seen in other layered structures like NaCoO₂ or in the related YBa₂Cu₃O₇. The unit cell volume expansion is therefore also linear and these observed effects show there is no structural change or significant oxygen content evolution from room temperature to 900° C. TGA in an air atmosphere confirmed these features with the sample showing no weight loss or gain outside of the error range of the measurement (0.1 oxygen per formula unit ie 0.02 when normalized to an ABO₃ formula unit) when heated and cooled back from room temperature to 1000° C. The diagonal tensor for thermal expansion then has coefficients α₁₁=9.8×10⁻⁶ K⁻¹, α₂₂=15.4×10⁻⁶ K⁻¹ and α₃₃=10.2×10⁻⁶ K⁻¹ along a, b and c respectively which results in a volumetric thermal expansion coefficient αᵥ=α₁₁+α₂₂+α₃₃=35.4×10⁻⁶ K⁻¹ over the range 25 to 900° C. The phase stability in CO₂ was evaluated by annealing the sample under pure CO₂ at 700° C. for 24 h. The material remained unchanged after this treatment in contrast to some other Ba-containing candidate cathode materials.

Powder neutron diffraction patterns were also collected at variable temperature. Room temperature data were analysed with the model determined by X-ray diffraction and showed some peaks for which the intensity could not be fitted although the d spacing was characteristic of the unit cell. Data collected at 450° C. showed a clear decrease in the intensity of these peaks relative to the rest of the diffraction diagram and data collected with a step of 5° C. showed this evolution until 480° C. after which temperature the decrease stopped. The intensity mismatch between calculated and experimental curves at room temperature was therefore attributed to magnetic scattering and the magnetic transition temperature was in the range 480 to 485° C.

To assess the cation ordering in the structure, the effect of the magnetic Bragg scattering was removed by analysing the data above the magnetic ordering temperature and carrying out combined X-ray/neutron analysis on a 485° C. powder neutron diffraction diagram and a 500° C. powder X-ray diffraction diagram. Unit cell parameters were allowed to refine freely between the two sets of data while all the atomic parameters were considered identical which was considered to be a sensible assumption given the small temperature difference and the observations made during the variable temperature PXD experiment. The structural model was refined using the results of the previous characterizations but this time with the introduction of all A-site cations. The Imma space group leads to an average model for the iron tetrahedral chains with two possible orientations, each present with a fraction of 50%. Due to the more sensitive detection of oxygen scattering by neutron diffraction, the I2mb space group with ordered tetrahedral orientations was also tested for the structure determination. However the refinement could not be stabilized when refining 6 of the 7 oxygen positions that change from special to general positions with the change from Imma to I2mb. Moreover Fourier difference maps show the two different tetrahedral orientations in the I2mb model which then also leads to an average disordered structure. Neither of the two iron sites generated by these two orientations could be stably refined. These considerations show that the Imma space group is preferred for the determination of cation ordering in the structure.

Firstly Ba, Ca and Y were fixed at arbitrary occupations in the different A-sites with Ca and Ba introduced initially in the sites showing weaker and stronger X-ray scattering respectively. Atomic as well as thermal parameters could be successively refined for all positions. It was possible to refine the cation occupancy on each A-site with the only constraint applied being a total occupancy of one for each site. Results for the eight-coordinate site gave the composition Ba_{-0.03}Ca_{0.40}Y_{0.63} and this layer was considered as Ba free to obtain the final results
Ca_{0.34(1)}Y_{0.66(1)} for the eight coordinate site
Ba_{0.05(1)}Ca_{0.80(1)}Y_{0.15(1)} for the nine coordinate site
Ba_{0.90(1)}Ca_{0.08(1)}Y_{0.02(1)} for the twelve coordinate site.

This confirms the strong preferential ordering indicated by the X-ray diffraction study. Barium is located almost exclusively on the twelve coordinate site which is associated with the observation of longer A-O distances (Table 2) in agreement with the larger Ba²⁺ ionic radius compared to Ca²⁺ or Y³⁺. On the other hand, the nine coordinate site strongly favours the presence of calcium while the eight coordinate site results in an oxygen and barium-free mixed Ca/Y layer as observed in numerous copper oxides (see FIG. 5). In parallel, oxygen sites were refined to occupancies of 0.97(1), 1.05 (1), 0.95 (1), 1.02 (1), 0.50 (1), 1.01 (1) and 0.97(1) for O1, O2, O3, O4, O5, O6 and O7 respectively and for such small deviations were considered to be fully occupied with the exception of O5 associated with the tetrahedral chain disorder discussed above which was considered half occupied. No extra oxygen could be detected in the Fourier difference maps. In that sense, this compound shows a distinct behaviour when compared to Ba₂Ca₂Nd₂Fe₆O_{15.6} where partial occupancy of oxygen sites (ideally fully vacant in the perfect intergrowth) in the equatorial plane of the tetrahedra can be observed at 500° C. accompanied/compensated by an oxygen deficiency at the level of the apical oxygen of these tetrahedra. This phenomenon was associated with a high temperature order-disorder transition similar to those reported for brownmillerite materials. In the present case, the absence of this transition is not only evidenced by the refined occupancies and Fourier difference maps but also by the previously discussed linear evolution of cell parameters over the temperature range room temperature to 900° C. Structural parameters and interatomic distances are summarized in Tables 1 and 2 whilst the experimental, calculated and difference curves are also presented for each of the high temperature refinements in FIG. 4 accompanied with reliability factors for each data bank.

TABLE 1
Structural parameters of Ba_{1.6}Ca_{2.3}Y_{1.1}Fe₅O₁₃ from combined refinements
above the Neel transition temperature. The unconstrained refined content for
the A-site cations is Ba_{1.9}Ca_{2.1}Y as discussed above.

| atom | multiplicity | Occupancy | x | y | z | Bᵢₛₒ (Å⁻²) |
|---|---|---|---|---|---|---|
| Fe1 | 8h | 1 | 0 | 0.04934(1) | 0.5055(3) | 0.61(2) |
| Fe2 | 8h | 1 | 0 | 0.15307(1) | 0.5066(2) | 0.84(2) |
| Fe3 | 8i | 0.5 | 0.0611(3) | ¼ | 0.5740(3) | 0.33(3) |
| O1 | 8g | 1 | ¼ | 0.03914(3) | ¼ | 2.28(5) |
| O2 | 8g | 1 | ¼ | 0.96318(3) | ¼ | 1.14(4) |
| O3 | 8g | 1 | ¼ | 0.15099(4) | ¼ | 1.27(4) |
| O4 | 8g | 1 | ¼ | 0.65833(3) | ¼ | 1.31(4) |
| O5 | 8i | 0.5 | 0.4001(5) | ¼ | 0.6093(6) | 1.54(6) |
| O6 | 8h | 1 | 0 | 0.09801(3) | 0.5179(4) | 1.66(3) |
| O7 | 8h | 1 | 0 | 0.20811(3) | 0.4391(4) | 2.48(5) |
| Ba1 | 4a | 0^{a} | 0 | 0 | 0 | 1.38(4) |
| Ca1 | 4a | 0.34(1) | 0 | 0 | 0 | 1.38(4) |
| Y1 | 4a | 0.66(1) | 0 | 0 | 0 | 1.38(4) |
| Ba2 | 8h | 0.90(1) | 0 | 0.59981(1) | −0.0043(3) | 1.92(2) |
| Ca2 | 8h | 0.08(1) | 0 | 0.59981(1) | −0.0043(3) | 1.92(2) |
| Y2 | 8h | 0.02(1) | 0 | 0.59981(1) | −0.0043(3) | 1.92(2) |
| Ba3 | 8h | 0.05(1) | 0 | 0.69313(2) | −0.0232(4) | 1.32(4) |
| Ca3 | 8h | 0.80(1) | 0 | 0.69313(2) | −0.0232(4) | 1.32(4) |
| Y3 | 8h | 0.15(1) | 0 | 0.69313(2) | −0.0232(4) | 1.32(4) |

Space group: Imma, a = 5.5318(3) Å, b = 38.569(2) Å, c = 5.5776(3) Å a: −0.03 when refined.

TABLE 2
a) principal Fe—O and A—O distances (Å) for the different
sites, b) principal O—Fe—O angles in Fe polyhedra and bridging
Fe—O—Fe angles from the combined refinement of Ba_{1.6}Ca_{2.3}Y_{1.1}Fe₅
O₁₃ above the Neel transition temperature
a)

| | n × distance (Å) | | n × distance (Å) |
|---|---|---|---|
| (Fe1)—(O1) | 2 × 2.0243(8) | (A2)—(O1) | 2 × 3.0440(14) |
| (Fe1)—(O2) | 2 × 2.0015(8) | (A2)—(O2) | 2 × 3.1347(14) |
| (Fe1)—(O6) | 1.8784(17) | (A2)—(O3) | 2 × 2.7726(13) |
| | | (A2)—(O4) | 2 × 3.0031(14) |
| (Fe2)—(O3) | 2 × 1.9918(7) | (A2)—(O6) | 2 × 2.76952(10) |
| (Fe2)—(O4) | 2 × 1.9485(7) | (A2)—(O6) | 2.865(2) |
| (Fe2)—(O6) | 2.1247(17) | (A2)—(O6) | 2.714(2) |
| (Fe2)—(O7) | 2.1558(14) | (A3)—(O3) | 2 × 2.4808(15) |
| (Fe3)—(O5) | 1.885(3) | (A3)—(O4) | 2 × 2.4568(15) |
| (Fe3)—(O5) | 1.979(3) | (A3)—(O5) | 2 × 2.3796(16) |
| (Fe3)—(O7) | 2 × 1.8141(13) | (A3)—(O7) | 2 × 2.8334(4) |
| (A1)—(O1) | 4 × 2.4770(9) | (A3)—(O7) | 2.391(2) |
| (A1)—(O2) | 4 × 2.4235(9) | | |

b)

| | n × angle (°) | | n × angle (°) |
|---|---|---|---|
| (O1)—(Fe1)—(O1) | 86.18(3) | (O5)—(Fe3)—(O5) | 110.8(2) |
| (O1)—(Fe1)—(O2) | 2 × 154.80(3) | (O5)—(Fe3)—(O7) | 2 × 103.23(16) |
| (O1)—(Fe1)—(O2) | 2 × 87.75(3) | (O5)—(Fe3)—(O7) | 2 × 106.63(17) |
| (O1)—(Fe1)—(O6) | 2 × 102.72(10) | (O7)—(Fe3)—(O7) | 125.90(11) |
| (O2)—(Fe1)—(O2) | 87.41(3) | | |
| (O2)—(Fe1)—(O6) | 2 × 102.47(10) | (Fe1)—(O1)—(Fe1) | 157.58(7) |
| | | (Fe1)—(O2)—(Fe1) | 152.07(7) |
| (O3)—(Fe2)—(O3) | 87.94(3) | (Fe2)—(O3)—(Fe2) | 175.37(6) |
| (O3)—(Fe2)—(O4) | 2 × 90.69(3) | (Fe2)—(O4)—(Fe2) | 168.06(6) |
| (O3)—(Fe2)—(O4) | 2 × 176.04(3) | (Fe3)—(O5)—(Fe3) | 122.77(6) |
| (O3)—(Fe2)—(O6) | 2 × 88.91(9) | (Fe1)—(O6)—(Fe2) | 176.19(9) |
| (O3)—(Fe2)—(O7) | 2 × 85.08(7) | (Fe2)—(O7)—(Fe3) | 143.56(7) |
| (O4)—(Fe2)—(O4) | 90.43(3) | | |
| (O4)—(Fe2)—(O6) | 2 × 94.78(9) | | |
| (O4)—(Fe2)—(O7) | 2 × 91.10(8) | | |
| (O6)—(Fe2)—(O7) | 171.64(12) | | |

From these refinements, the composition of the phase is Ba_{1.90}Ca_{2.10} Y_{1.00}Fe₅O₁₃ which leads to a pure Fe³⁺ compound with a perovskite superstructure (see FIG. 5). It should be noted that the only constraint applied to the refined A-site composition was the total occupancy of each site and therefore this formula can be considered to be in good agreement with the EDS results Ba_{1.62}Ca_{2.32}Y_{1.06}Fe_{5.10} or the nominal composition Ba_{1.7}Ca_{2.4}Y_{0.9}Fe₅. Furthermore tests of composition fixed to the EDS or nominal contents did not have a major impact on the reliability factors of the structural refinement which could explain the observed difference in derived compositions. Since X-ray and neutron diffraction are not the most reliable techniques for chemical composition analysis, the A-site composition was addressed by the EDS analysis resulting in the formula Ba_{1.6}Ca_{2.3}Y_{1.1}Ye_{1.1}Fe₅O₁₃ (Fe^{+2.98}) considering as well that maximal deviations of 0.2 were observed on these formula unit numbers by this technique.

Iron coordination polyhedra are shown in FIG. 6. From the high temperature combined refinements, bond valence sum (BVS) calculations led to 2.99, 2.75 and 2.98 for the tetrahedral, square based pyramidal and octahedral sites respectively. Remarkably a shortening of the apical Fe—O distances was observed for the 4 and 5 coordinate sites (1.81 and 1.88 Å) as opposed to an extension for the 6 coordinate site (2.12 and 2.18 Å). This difference is not found at the level of the equatorial distances with limiting values of 1.88 (for the tetrahedra) and 2.02 Å (for the square based pyramid). This phenomenon is also observed in YBa₂Fe₃O₈ and Ca₂Fe₂O₅ and emphasizes the perovskite structure flexibility which plays a crucial role in the stabilization of the ten layered stacking. On another hand, in Nd₂Ba₂Ca₂Fe₆O_{15.6} obtained under highly reducing conditions, a trigonal planar environment accommodating Fe²⁺ was suggested due to significant bond length and angle discrepancies for the ideal tetrahedral arrangement. In the present case this possible interpretation of the refined model would lead to one extremely short Fe—O equatorial distance (1.78 Å), whilst reducing the BVS to 2.66. The tetrahedral arrangement is favoured in the present Fe³⁺ compound supported as well by a less distorted tetrahedral geometry (mainly at the level of bond angles) than in the case of Nd₂Ba₂Ca₂Fe₆O_{15.6} where the presence of non-spherical Fe²⁺ on this site drives the lowering of the symmetry of the polyhedra. For example, in a tetrahedral site in Nd₂Ba₂Ca₂Fe₆O_{15.6} bond angles of 97° and 115° are observed for the shortest contacts, while their equivalents are 103° and 107° in Ba_{1.6}Ca_{2.3}Y_{1.1}Fe₅O₁₃ confirming the two distinct environments. As for the pyramidal and octahedral sites, no such significant difference was observed between the two compounds with respective bond valence sums of 2.64 and 3.11 in the Nd-containing compound (compared with 2.75 and 2.98 in the present case). The geometry of these square based pyramids and octahedra compares well in both structures with a shorter apical bond found in the square based pyramid and two longer apical bonds found in the octahedra. These findings confirm that the lowest coordinated site is most probably the host for Fe²⁺ in Nd₂Ba₂Ca₂Fe₆O_{15.6} and that this site is occupied by Fe³⁺ in Ba_{1.6}Ca_{2.3}Y_{1.1}Fe₅O₁₃, whilst Fe1 and Fe2 are in similar environments and contain Fe³⁺ in both compounds.

### Physical Characterization

The transport properties of the material were investigated as a function of temperature. A semiconducting behaviour was observed over the temperature range 300-900° C. with values of conductivity increasing from 0.53 to 2.59 S.cm⁻¹ (see FIG. 7). These values denote the lack of charge carriers in the compound for which electronic properties are governed by the predominance of Fe³⁺. A change of slope was observed in the ln σ vs 1/T curve at ˜480° C. that can be correlated with the magnetic transition temperature T_{N}. This effect was reported in the Nd₁₋ₓCaₓFeO_{3-y} system and attributed to a variation of electrical activation energy after the change in spin alignment. The activation energies were calculated to be 200 and 111 meV below and above the T_{N} of the material respectively which compares well with Fe³⁺ parent systems YBa₂Fe₃O₈ and Ca₂Fe₂O₅ (420 meV and 280 meV respectively). The conductivity of the sample also showed total reversibility upon a cycle of cooling and heating which is consistent with the high stability of the sample and the fixed oxygen content over the studied temperature range.

AC impedance spectroscopy was performed on a symmetrical cell with Sm-doped cerium dioxide as the electrolyte to evaluate the electrochemical activity of this phase towards the ORR (see FIG. 8) after checking that the materials showed no reaction together (FIG. 9). At 700° C. and below, the AC impedance arcs were modelled by an equivalent circuit composed of an ohmic resistance (representing the resistance associated with the electrolyte and the cables) in series with two resistors, each in parallel with a constant phase element (CPE) (representing the electrode processes of mass transport and charge transfer). Above 700° C., the impedance arcs could be modelled by an ohmic resistance in series with a single resistor-CPE in parallel indicating that at these temperatures the cathode rate limiting step is dominated by a single process. The DC conductivity measurements indicate that the electrical conductivity of the ten-layer material is several orders of magnitude lower than that of common SOFC cathode materials with a value of 0.5 S.cm⁻¹ at 700° C. compared with 320 S.cm⁻¹ for the widely used iron-rich cathode La_{0.6}Sr_{0.4}Fe_{0.8}CO_{0.2}O_{3-δ} at the same temperature. This suggests that the cathode performance (ASR) is likely to be limited by low electronic conductivity correlated with the lack of charge carriers in this material. However the value of the area specific resistance of 0.87 Ω.cm² at 700° C. (see FIG. 7) compares with cobalt-free Ba_{0.5}Sr_{0.5}Fe_{0.8}Zn_{0.2}O_{3-δ} (0.22 Ω.cm² at 700° C.) or the widely used iron-rich cathode La_{0.6}Sr_{0.4}Fe_{0.8}Co_{0.2}O_{3-δ} (0.44 Ω.cm² at 690° C. on Gd-doped ceria) while remaining one order of magnitude higher than the best values obtained for cobalt compounds like SmBa_{0.5}Sr_{0.5}Co₂O_{5+δ} (0.019 Ω.cm² at 700° C. on Gd-doped ceria). If one supposes that the rate limiting process of this low conducting material is charge transfer whereby the adsorbed oxygen species combine with electronic charge carriers to form O²⁻ ions, the relatively low ASR indicates an enhanced activity for the contributions related to the mass transport processes of oxygen adsorption and incorporation as well as oxygen ion diffusion in the bulk to balance the overall behaviour. In that sense, the ten layered ordered structure could be directly responsible for these phenomena with fully oxygen deficient layers favouring atomic diffusion. Indeed with the presence of FeO₅ square-based pyramid layers, this material has common structural features to one of the most promising class of mixed conductors (LnBaCo₂O₅₊ₓ (Ln=lanthanide) materials) showing excellent activity toward the ORR process. Furthermore the complex atomic ordering might induce the presence of specific transition metal polyhedra on the cathode surface which could improve catalytic activity in comparison to a simple perovskite material. Emphasizing that point is the lower activation energy found for the ten layered Ba_{1.6}Ca_{2.3}Y_{1.1}Fe₅O₁₃ (Eₐ=1381 Ω.mol⁻¹) than for cubic phases such as La_{0.8}Sr_{0.2}CoO_{3-δ} (Eₐ=1641 Ω.mol⁻¹), La_{0.8}Sr_{0.2}FeO_{3-δ} (Eₐ=183 kJ.mol⁻¹) or La_{0.8}Sr_{0.2}CO_{0.8}Fe_{0.2}O_{3-δ} (Eₐ=202 kJ.mol⁻¹). It should also be noted that this ASR was obtained without any optimization of the cathode microstructure and a relatively high cell firing temperature of 1150° C. It is well known that improving the cathode microstructure and reducing the cell firing temperature can lead to a significant reduction in ASR values which suggests that further improvements in ASR values can be made.

### Discussion

Ba_{1.6}Ca_{2.3}Y_{1.1}Fe₅O₁₃ is isostructural with Ba₂Ca₂Nd₂Fe₆O_{15.6} and can be described as a regular intergrowth between Ca₂Fe₂O₅ and YBa₂Fe₃O₈ leading to a complex superstructure displaying 20 times the unit cell volume of a classic cubic perovskite (FIG. 1). However the distinct compositions and preferences of the trivalent A-site cation lead to considerable changes in the A-site ordering. Indeed Ba_{1.6}Ca_{2.3}Y_{1.1}Fe₅O₁₃ shows a degree of order superior to Ba₂Ca₂Nd₂Fe₆O_{15.6} when compared with the ideal (Y,Nd)Ba₂Ca₂Fe₅O₁₃ intergrowth where the eight-coordinate site is occupied by Y³⁺ (Nd³⁺), the nine-coordinated site is occupied by Ca²⁺ and the twelve-coordinate site is occupied by Ba²⁺. This perfect ordering is not reached in either of the two compounds but is clearly stronger in Ba_{1.6}Ca_{2.3}Y_{1.1}Fe₅O₁₃ which can be described as well ordered with 66% Y³⁺, 80% Ca²⁺ and 90% Ba²⁺ on the sites that should be fully occupied by each of these cations in an ideal intergrowth. It may be difficult to avoid Y³⁺—Ca²⁺ site disorder due to their close ionic radii which should provoke deviations from the ideal ordering. Taking these considerations into account, it should be noted that the eight and nine coordinated sites are almost exclusively filled with the smaller Y³⁺ and Ca²⁺ cations at 100% and 95% respectively, while the larger Ba²⁺ is still 90% of the twelve coordinated A-site. In Ba₂Ca₂Nd₂Fe₆O_{15.6}, the comparable occupancy numbers are 75% Nd³⁺, 43% Ca²⁺, 40% Ba²⁺ in the expected sites which clearly shows that the ordering in nine and twelve-coordinated sites is not as well achieved (although a preferential ordering is still observed). This has to be also seen as a result of a composition which slightly deviates from the ideal LnBa₂Ca₂Fe₅O₁₃ (Ln=lanthanide or Y) added to the fact that Nd³⁺ has a greater ionic radius than Y³⁺ which might favour the possibility of Ba/Nd mixed layers more strongly.

Moreover strong differences are also observed in the chemical behaviour of the two ten layer structures. Ba₂Ca₂Nd₂Fe₆O_{15.6} is only obtained after several heating cycles in various atmospheres with a final highly reducing treatment in the presence of a Zr getter affording an air sensitive material most probably because of the low Fe oxidation state of +2.66. In contrast, a careful selection of the cation composition allows Ba_{1.6}Ca_{2.3}Y_{1.1}Fe₅O₁₃ to be stabilized under ambient conditions by a more straightforward synthetic process. Several characterization techniques are consistent with the presence of the Fe³⁺ oxidation state which leads to the different stability of the two ten layer perovskites.

Indeed the structure shows a clear robustness upon heating (as seen in the X-ray thermodiffraction measurements). The ten layer structure of Ba_{1.6}Ca_{2.3}Y_{1.1}Fe₅O₁₃ is not only accessible under more oxidising conditions than Ba₂Ca₂Nd₂Fe₆O_{15.6} but is also stable over a wide temperature range. Along with the Fe³⁺ oxidation state that is well-suited to ambient atmosphere stability, the cation ordering that goes with preferential coordination numbers for each A-site imposes a specific oxygen sublattice along the stacking sequence. This “cation-imposed” oxygen ordering might be why the superstructure is retained even at high temperature while in the less ordered (at the A-site level) reduced Ba₂Ca₂Nd₂Fe₆O_{15.6}, the oxygen sublattice undergoes an order-disorder transition starting as low as 500° C.

Ba_{1.6}Ca_{2.3}Y_{1.1}Fe₅O₁₃ has some advantages for high temperature applications due to its thermal stability and lack of reactivity to common electrolytes and to CO₂. The observed ASR is significantly lower than would be expected based on the poor de conductivity which suggests that the combined oxide ion transport and oxygen reduction catalysis performance is good. Good ionic conductivity can be explained by the presence within the structure of the oxygen-free rock salt layers found in some of the most promising solid oxide fuel cell cathodes such as the 112 perovskites LnBaCo₂O_{5+δ} (Ln=lanthanide or Y). Since it has been proposed that square based pyramids are favourable environments for transition metals to catalyse dioxygen molecule dissociation (while tetrahedral Fe³⁺ will be shielded from O₂ attack) and given that the specific A-site ordering might also form these polyhedra at the surface of the material, the 112-type layers could also be important for catalytic behaviour. Once the dissociation process has occurred, oxide anions can easily diffuse through the fully oxygen deficient layer available at the same level of the crystal structure. Such considerations may contribute to the low activation energy found for the ORR process in Ba_{1.6}Ca_{2.3}Y_{1.1}Fe₅O₁₃ compared to simpler cubic perovskites.

Concerning parameters related to the SOFC stability, the volumetric thermal expansion coefficient (αᵥ=35.4×10⁻⁶ K⁻¹) of Ba_{1.6}Ca_{2.3}Y_{1.1}Fe₅O₁₃ is strikingly similar to the SDC electrolyte (αᵥ=37.5×10⁻⁶ K⁻¹) when compared to αᵥ=49.2×10⁻⁶ K⁻¹ in GdBaCo₂O_{5+δ} or 57.6-68.7×10⁻⁶ K⁻¹ of the simple cubic perovskite Ba_{0.5}Sr_{0.5}CO_{0.8}Fe_{0.2}O_{3-δ} (values extrapolated from linear thermal expansion coefficients given in A. Tarancón, D. Marrero-López, J. Peña-Martinez, J. C. Ruiz-Morales, P. Núñez, Solid State Ionics 179 (2008), 611-618; and Q. Zhu, T. Jin, Y. Wang, Solid State Ionics 177 (2006) 1199-1204).

Additionally as a complementary test of the compound stability, the sample was annealed at 700° C. for 24 h under pure CO₂. While this treatment is known to result in total phase decomposition for some related Ba-containing perovskites such as GdBaCo₂O_{5+δ} with the formation of BaCO₃, the sample remains unchanged after annealing and no trace of BaCO₃ was observed. The material can still be considered as rich in barium which is approximately ⅓ of the total A-site composition. Moreover Ba₁₋ₓSrₓCo_{0.8}Fe_{0.2}O_{3-δ} shows carbonate formation for the well known x=0.5 compound and the x=0.8 compound where Ba represents only ⅕ of the A-site composition. This emphasises the robustness of the present ten layer compound.

### Example 2

Polycrystalline samples were prepared via a direct solid state reaction of Y₂O₃ (99.999%), BaCO₃ (99.95%), CaCO₃ (99.95%), Fe₂O₃ (99.945%) and CuO (99.95%) (all sourced from Alfa Aesar) mixed and ground by hand in the desired cationic ratios and fired at 1200° C. in alumina crucibles lined with platinum foil under ambient air atmosphere. Heating and cooling was direct to temperature with a heating time of 18 hours. Several cycles of regrinding and firing were performed to ensure phase homogeneity and to complete the reaction process. Phase and purity identification was carried out by powder X-ray diffraction collected on a Panalytical system using Co Kα₁ radiation in Bragg Brentano geometry.

Reaction at the Y_{2.24}Ba_{2.28}Ca_{3.48}Fe_{7.44}Cu_{0.56}O_{21±δ} composition provided a material with the unit cell dimensions α=5.479 Å, b=61.29 Å and c=5.547 Å (space group Imma). The resulting structure is shown in FIG. 10 and has a volume 32 times that of the basic perovskite unit cell. The structure consists of 3 different coordination environments for Fe, namely square pyramidal (S), octahedral (O) and tetrahedral (T). There are 4 crystallographically distinct sites for the Y, Ba and Ca cations. Y cations preferentially occupy 8 coordinate sites (between S Fe layers) and 12 coordinate sites (between O Fe layers) while the larger Ba cations preferentially occupy 12 coordinate sites (between S and O Fe layers). Ca cations preferentially occupy two chemically similar 8 coordinate sites (between O and T Fe layers). The material of Example 1 has the iron coordination environment sequence SOTOS, whereas the material of this Example has the composition SOTOOTOS. In other words, an extra OOT sequence is inserted between the T and O of Example 1. The composition range where this 16aₚ structure is the main phase (90%+) is Y_{2.16-2.32}Ba_{2.36-2.48}Ca_{3.28-3.52}Fe_{7.44}Cu_{0.56}O_{21±δ}.

Stability and chemical compatibility tests between the cathode (Y_{2.32}Ba_{2.16}Ca_{3.52}Fe_{7.44}Cu_{0.56}O_{21±δ}) and the electrolytes samarium doped ceria (SDC, Ce_{0.8}Sm_{0.2}O₂), gadolinium doped ceria (GDC, Ce_{0.9}Gd_{0.1}O₂) and lanthanum strontium gallium magnesium oxide (LSGM, La_{0.9}Sr_{0.1}Ga_{0.8}Mg_{0.2}O₃) were carried out. The cathode and electrolyte were mixed in a 1:1 ratio, pressed into pellets and fired at 750° C. for five days as well as separate samples at 950° C. for five hours before being analysed by PXRD. No new phases were found to be present and lattice parameters remained stable indicating that this phase is stable with commonly used electrolytes. A symmetrical cell composed of Y_{2.32}Ba_{2.16}Ca_{3.52}Fe_{7.44}CU_{0.56}O₂₁/SDC/Y_{2.32}Ba_{2.16}Ca_{3.52}Fe_{7.44}Cu_{0.56}O₂₁ was produced by screen printing a layer of Y_{2.32}Ba_{2.16}Ca_{3.52}Fe_{7.44}Cu_{0.56}O₂₁ onto each side of a dense SDC pellet and adhering the layers by calcining at 950° C. for one hour. Evaluation of the behaviour as an SOFC cathode produced the area specific resistance values shown in units of Ω.cm² in Table 3 below.

TABLE 3

| Temperature | |
|---|---|
| 500 | 39.23 |
| 550 | 9.15 |
| 600 | 2.21 |
| 650 | 0.79 |
| 700 | 0.28 |
| 750 | 0.12 |
| 800 | 0.07 |

1. A mixed metal oxide exhibiting perovskite-type structural characteristics in which there are cations of:
Ba;
X, wherein X denotes Ca or Sr;
Z, wherein Z denotes a rare earth metal; and
T, wherein T denotes Fe, Cr, Cu, Co or Mn and is present in three different coordination sites,
wherein one or more of the cations is optionally partially substituted by a metal dopant, or a composition thereof.

2. The mixed metal oxide as claimed in claim 1 wherein the three different coordination sites include a substantially square pyramidal coordination site.

3. The mixed metal oxide as claimed in claim 1 wherein the three different coordination sites are substantially octahedral, square pyramidal and tetrahedral.

4. The mixed metal oxide as claimed in claim 1 wherein T is Fe.

5. The mixed metal oxide as claimed in claim 1 wherein the perovskite-type structural characteristics are attributable to a perovskite superstructure.

6. The mixed metal oxide as claimed in claim 5 wherein the perovskite superstructure is indexable on a unit cell with a volume which is 5 or more times the volume of the perovskite unit cell, more preferably 10 or more times the volume of the perovskite unit cell, especially preferably 15 or more times the volume of the perovskite unit cell, more preferably 20 or more times the volume of the perovskite unit cell, even more preferably 32 or more times the volume of the perovskite unit cell.

7. The mixed metal oxide as claimed in claim 1 wherein the perovskite-type structural characteristics are attributable to a layered perovskite structure which has 5 or more layers, more preferably 8 or more layers, especially preferably 10 or more layers, more especially preferably 16 or more layers.

8. The mixed metal oxide as claimed in claim 1 wherein the structure of the mixed metal oxide features twelve coordinate, nine coordinate and eight coordinate sites.

9. The mixed metal oxide as claimed in claim 1 wherein the rare earth metal Z is La, Sm, Gd, Y or Dy, preferably Gd, Sm, Y or Dy, more preferably Y.

10. The mixed metal oxide as claimed in claim 1 wherein X denotes Ca.

11. The mixed metal oxide as claimed in claim 1 wherein the perovskite-type structural characteristics are attributable to a structure with an asymmetric crystallographic unit of chemical formula:
A₅B₅O_{13±δ}
wherein:
A denotes a site occupied predominantly by Ba, X and Z;
B denotes a site occupied predominantly by T; and
δ denotes optional oxygen non-stoichiometry.

12. The mixed metal oxide as claimed in claim 1 which has a structural unit of formula:
Ba_{y}XₓZ_{z}TₙO_{13±δ}
wherein:
X, Z and T are as defined in any preceding claim;
y is in the range 1.0 to 3.0;
x is in the range 1.0 to 3.0;
z is in the range 0.5 to 2.0;
x+y+z is in the range 4.9 to 5.1;
n is in the range 4.9 to 5.1; and
δ denotes optional oxygen non-stoichiometry,
wherein one or more of Ba, X, Z and T is optionally partially substituted by a metal dopant.

13. The mixed metal oxide as claimed in claim 1 which has a structural unit of formula Ba_{1.6}X_{2.3}Z_{1.1}T₅O₁₃, particularly preferably a structural unit of formula Ba_{1.6}X_{2.3}Y_{1.1}Fe₅O₁₃ or Ba_{1.6}Ca_{2.3}Z_{1.1}Fe₅O₁₃, especially preferably a structural unit of formula Ba₁₆Ca_{2.3}Y_{1.1}Fe₅O₁₃.

14. The mixed metal oxide as claimed in claim 1 wherein the perovskite-type structural characteristics are attributable to a structure with an asymmetric crystallographic unit of chemical formula:
A₈B₈O_{21±δ}
wherein:
A denotes a site occupied predominantly by Ba, X and Z;
B denotes a site occupied predominantly by T; and
δ denotes optional oxygen non-stoichiometry.

15. The mixed metal oxide as claimed in claim 1 which has a structural unit of formula:
BaₚX_{q}ZᵣTₛO_{21±δ}
wherein:
X, Z and T are as hereinbefore defined;
p is in the range 1.0 to 3.0;
q is in the range 3.0 to 4.0;
r is in the range 2.0 to 3.0;
p+q+r is in the range 7.9 to 8.1;
s is in the range 7.9 to 8.1; and
δ denotes optional oxygen non-stoichiometry,
wherein one or more of Ba, X, Z and T is optionally partially substituted by a metal dopant.

16. The mixed metal oxide as claimed in claim 15 which has a structural unit of formula Ba_{2.2}X_{3.5}Z_{2.3}T₈O₂₁, particularly preferably a structural unit of formula Ba_{2.2}X_{3.5}Y_{2.3}Fe₈O₂₁, Ba_{2.2}Ca_{3.5}Y_{2.3}T₈O₂₁ or Ba_{2.2}Ca_{3.5}Z_{2.3}Fe₈O₂₁, especially preferably a structural unit of formula Ba_{2.2}Ca_{3.5}Y_{2.3}Fe_{7.4}Cu_{0.6}O₂₁.

17. The mixed metal oxide as claimed in claim 1 obtainable by a process comprising:
(A) preparing an intimate mixture of a substantially stoichiometric amount of a compound of each of Ba, X, Z, T and the optional metal dopant; and
(B) inducing a reaction in the intimate mixture to produce the mixed metal oxide or composition thereof.

18. The mixed metal oxide as claimed in claim 17 wherein the substantially stoichiometric amount of the compound of each of Ba, X, Z and T gives a cationic ratio of a:b:c:d, wherein:
a is in the range 1.6 to 2.2;
b is in the range 1.8 to 2.8;
c is in the range 0.2 to 1.2;
a+b+c is 5; and
d is 5.

19. The mixed metal oxide as claimed in claim 17 wherein the substantially stoichiometric amount of the compound of each of Ba, X, Z and T gives a cationic ratio of a′:b′:c′:d′, wherein:
a′ is in the range 2.1 to 2.6;
b′ is in the range 3.1 to 3.7;
c′ is in the range 2.0 to 2.5;
a′+b′+c′ is 8; and
d′ is 8.

20. The use of a mixed metal oxide or a composition thereof as defined in claim 1 as a cathode.

21. A mixed metal oxide exhibiting perovskite-type structural characteristics in which there are cations of:
Ba;
one of X or Z, wherein X and Z are as defined in claim 1; and
T, wherein T is as defined in claim 1 and is present in three different coordination sites,
wherein one or more of the cations is optionally partially substituted by a metal dopant
wherein the perovskite-type structural characteristics are attributable to a layered perovskite superstructure indexable on a unit cell with a volume which is 5 or more times the volume of the perovskite unit cell,
or a composition thereof.
